(19) United States
(12) Patent Application Publication
(10) Pub. No.: US 2026/0338253 A1
(43) Pub. Date: Oct. 29, 2026

(54) HEXAPOD CALIBRATION DEVICE

(71) Applicant: DELTA ELECTRONICS, INC., Taoyuan City (TW)

(72) Inventors: Chun-Tse LEE, Taoyuan City (TW); Chi-Li JI, Taoyuan City (TW); Shi-Yu WANG, Taoyuan City (TW)

(21) Appl. No.: 19/242,029

(22) Filed: Jun. 18, 2025

(30) Foreign Application Priority Data
Apr. 28, 2025 (CN) 202510546918.4

(51) Int. Cl. F16F 13/00

(52) U.S. Cl. CPC F16F 13/005; F16F 2222/08

(57) ABSTRACT

This disclosure is directed to hexapod calibration device having a base, a carrier, six linear buffers and a loading compensator. The carrier and the base are arranged in parallel, and a central axis is defined along a central connecting line of the carrier and the base. The linear buffers are arranged around the central axis. Each linear buffer has two ends respectively provided with universal joints respectively pivotally connect the base and the carrier. The loading compensator is connected to the base and the carrier and arranged along a predetermined operating direction so as to resist a load force between the base and the carrier in the predetermined operating direction.

### CROSS-REFERENCE TO RELATED APPLICATION

This patent application claims the benefit of China Patent Application No. 202510546918.4 filed Apr. 28, 2025, which is incorporated by reference herein.

### BACKGROUND OF THE DISCLOSURE

### Technical Field

This disclosure is directed to a hexapod calibration device, in particular to a hexapod calibration device having a load-bearing compensator.

### Description of Related Art

A hexapod calibration device is a synergistic motion platform (hexapod) structure having six elastic elements, and it is different from the synergistic motion platform in that the synergistic motion platform is an active actuation device having six actuators and difficult to be pushed by external forces. However, the hexapod calibration device is a passive device. When it is applied with forces, resistances are correspondingly formed in various directions by the elastic force caused by the elastic deformations of the elastic elements, so as to balance the forces.

The hexapod calibration device may be used for part assembly to absorb the deviation caused by part misalignment via freedom thereof in various directions. However, if a deformation on the elastic body is caused by the weight of the part carried thereon, rest space allowing further deformation in each elastic body is reduced, and overall amount of deviation absorbed by the hexapod calibration device is therefore decreased. Accordingly, the hexapod calibration device of related art usually performs a capacity of calibration below expectations.

In views of this, in order to solve the above disadvantage, the inventor studied related technology and provided a reasonable and effective solution in this disclosure.

### SUMMARY OF THE INVENTION

This disclosure is directed to a hexapod calibration device having a load-bearing compensator.

This disclosure is directed to a hexapod calibration device having a base, a carrier, six linear buffers and a load-bearing compensator. The carrier is arranged parallel to the base, and a central axis is defined on the center line connecting the carrier and the base. Six linear buffers are arranged around the central axis and respectively pivoted with the base and the carrier, and each of the linear buffers has two ends respectively provided with universal joints for pivoting. The load-bearing compensator has at least one linear elastic element connected to the base and the carrier. A compensation force along the operation direction is generated by an elastic deformation of the at least one linear elastic element when a load force is applied between the base and the carrier.

According to this disclosure, the at least one linear elastic element is disposed on the central axis.

According to this disclosure, the load-bearing compensator has a plurality of linear elastic elements coaxially disposed on the central axis.

According to this disclosure, the linear elastic elements are telescoped into one another.

According to this disclosure, the load-bearing compensator has a plurality of linear elastic elements disposed as an arrangement surrounding the central axis.

According to this disclosure, the linear elastic elements are arranged parallel to the central axis.

According to this disclosure, each of the linear elastic elements is tilted.

According to this disclosure, each of the linear elastic elements is tilted toward the same direction relative to a circumferential direction of the arrangement of the linear elastic elements.

According to this disclosure, the at least one of linear elastic elements is eccentrically arranged about the central axis.

According to this disclosure, the load-bearing compensator has a plurality of linear elastic elements, the linear elastic elements have a first linear elastic element and second linear elastic element with a modulus of elasticity the same as that of the first linear elastic element, and the first linear elastic element and the second linear elastic element are respectively disposed at different sides of the central axis.

According to this disclosure, the load-bearing compensator has a first sub-seat and a second sub-seat, the first sub-seat is detachably connected to one of the base and the carrier, the second sub-seat is detachably connected to another of the base and the carrier, and the at least one linear elastic element is connected to the first sub-seat and the second sub-seat.

Accordingly, the hexapod calibration device of this disclosure has a load-bearing compensator, thereby providing compensation force(s) along specific direction(s) for resisting a weight of load object, so that preload to the linear buffer may be reduced, and the hexapod calibration device may operate a calibration with a larger range.

### BRIEF DESCRIPTION OF THE DRAWINGS

FIG. 1 is an exploded view of the hexapod calibration device according to the first embodiment of this disclosure.

FIG. 2 is a perspective view showing the hexapod calibration device according to the first embodiment of this disclosure.

FIG. 3 is a top view of the hexapod calibration device according to the first embodiment of the disclosure.

FIG. 4A is a side view of the hexapod calibration device according to the first embodiment of the disclosure.

FIG. 4B is a perspective view showing another type of the linear buffer of the hexapod calibration device according to the first embodiment of this disclosure.

FIG. 5 is a perspective view showing the hexapod calibration device in operation.

FIG. 6 is another perspective view showing the hexapod calibration device in operation.

FIG. 7 is still another perspective view showing the hexapod calibration device in operation.

FIG. 8 is a perspective view showing the hexapod calibration device according to the second embodiment of this disclosure.

FIG. 9A is a top view of the hexapod calibration device according to the second embodiment of the disclosure.

FIG. 9B is a perspective view showing another type of the linear buffer of the hexapod calibration device according to the second embodiment of this disclosure.

FIG. 10 is a perspective view showing the hexapod calibration device according to the third embodiment of this disclosure.

FIG. 11A is a top view of the hexapod calibration device according to the third embodiment of the disclosure.

FIG. 11B is a perspective view showing another type of the linear buffer of the hexapod calibration device according to the third embodiment of this disclosure.

FIG. 12 is a perspective view showing the hexapod calibration device according to the fourth embodiment of this disclosure.

FIG. 13A is a top view of the hexapod calibration device according to the fourth embodiment of the disclosure.

FIG. 13B is a perspective view showing another type of the linear buffer of the hexapod calibration device according to the fourth embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

It should be understood that the orientations or positional relationships in this disclosure which are indicated by the terms such as “front side”, “rear side”, “left side”, “right side”, “front end”, “rear end”, “end”, “vertical”, “horizontal”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Detailed descriptions and technical contents of this disclosure is described in the flowing paragraph with reference to the drawings. However, the drawings are attached only for illustration and are not intended to limit this disclosure.

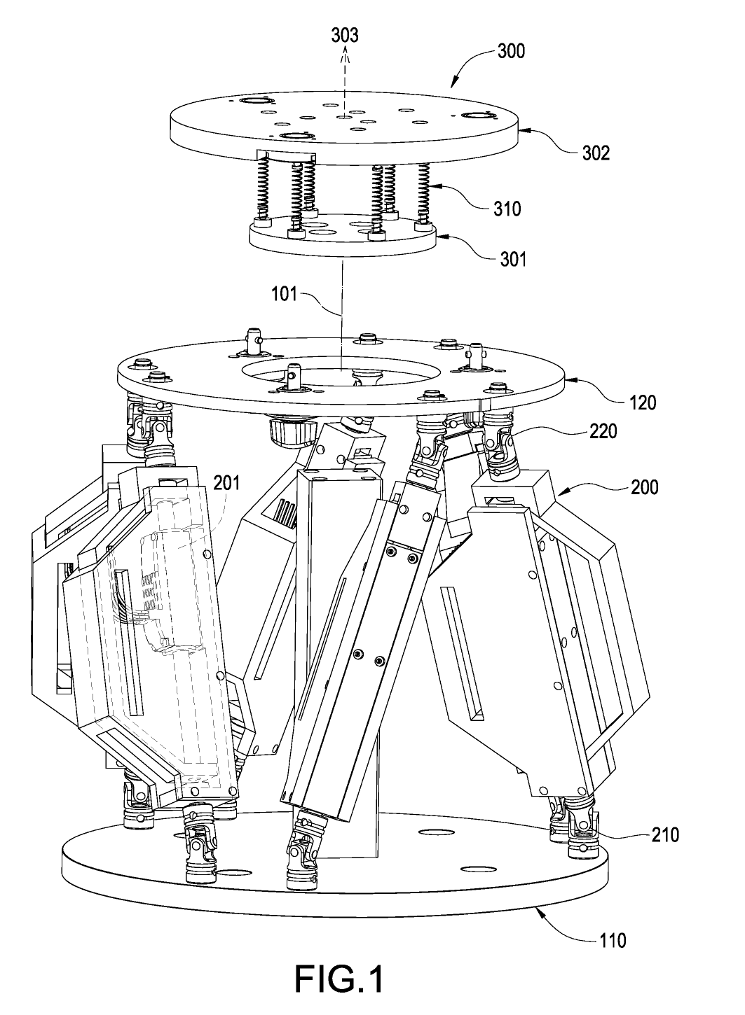

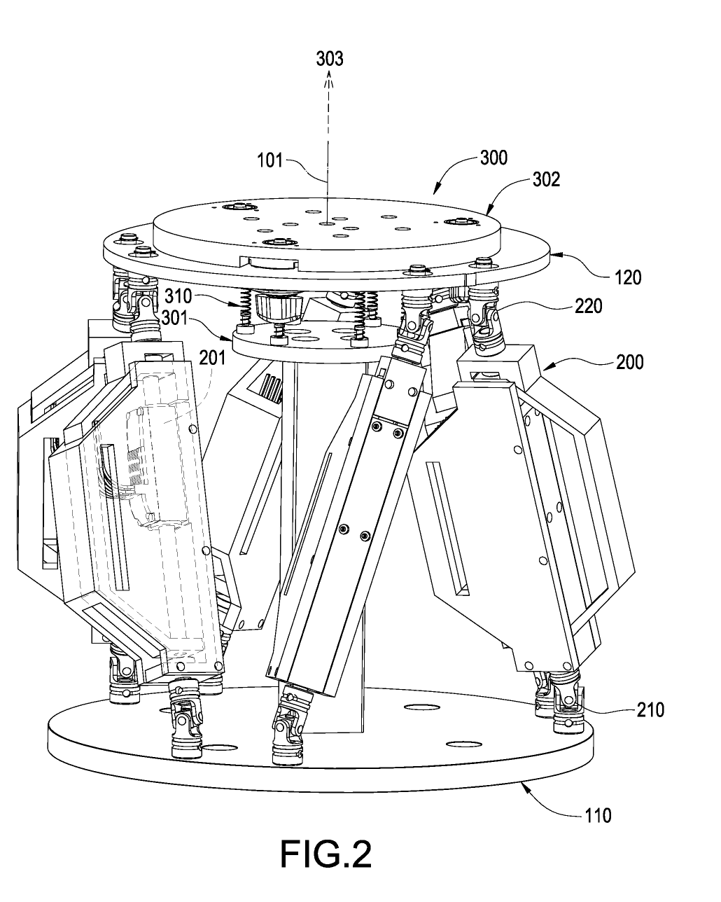

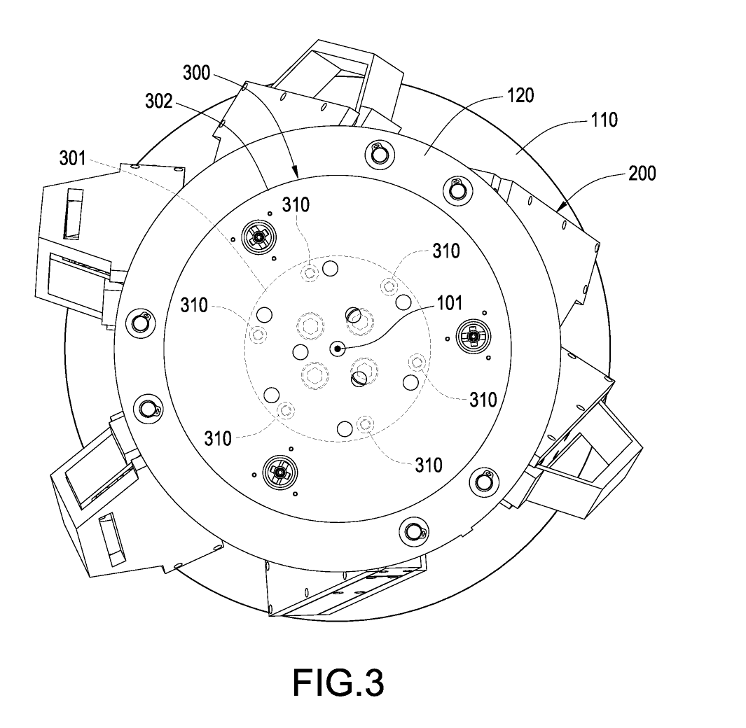

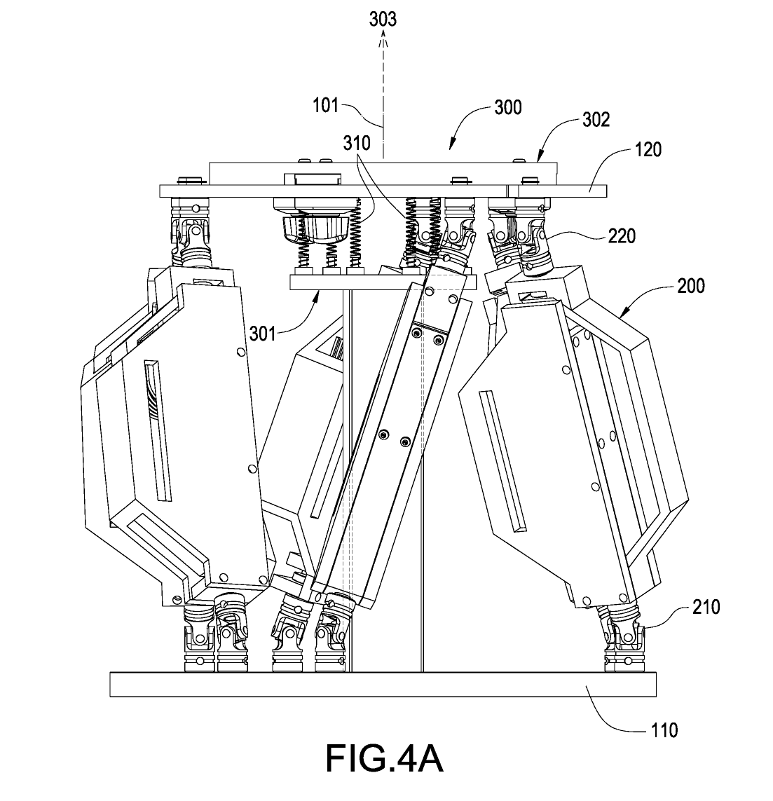

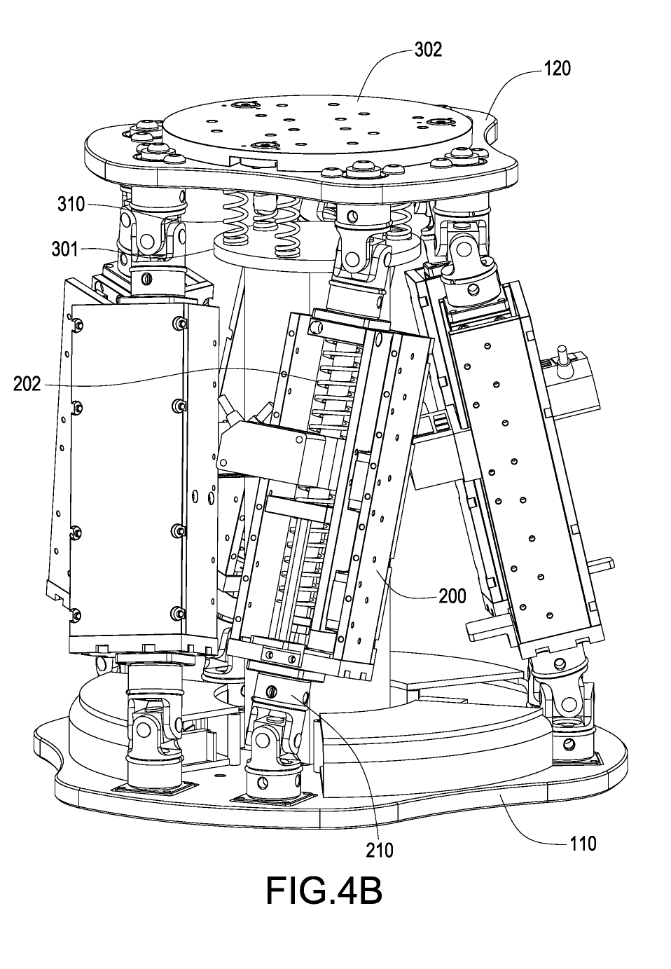

FIG. 1 is an exploded view of the hexapod calibration device according to the first embodiment of this disclosure. FIG. 2 is a perspective view showing the hexapod calibration device according to the first embodiment of this disclosure. FIG. 3 is a top view of the hexapod calibration device according to the first embodiment of the disclosure. FIG. 4A is a side view of the hexapod calibration device according to the first embodiment of the disclosure.

According to FIGS. 1-4A, the first embodiment of this disclosure provides a hexapod calibration device having a base 110, a carrier 120, six linear buffers 200 and a load-bearing compensator 300.

Both of the carrier 120 and the base 110 may be plates, but the scopes of this disclosure should not be limited to the embodiment, other structures may be attached onto the plate according to requirements. Moreover, the carrier 120 and the base 110 are arranged side by side (regarding the plate). In a general operation, the carrier 120 is arranged over the base 110, but the scopes of this disclosure should not be limited to the embodiment.

Each of the linear buffer 200 is connected between the base 110 and the carrier 120. In order to illustrate an arrangement of six linear buffers 200, a central axis 101 is defined on a connecting line through centers of the carrier 120 and the base 110. The six linear buffers 200 are disposed around the central axis 101. Each of the linear buffers 200 has two ends respectively provided with universal joints for pivoting, and the universal joints (210, 220) are respectively connected to the base 110 and the carrier 120, thereby connecting the linear buffer 200 between the base 110 and the carrier 120. According to this embodiment, each of the linear buffer 200 has a telescopic rod 201, the linear buffer 200 may telescope along an axial direction of the telescopic rod 201. According to this embodiment as shown in FIGS. 1-4A, the telescopic rod 201 may be an active telescopic buffering element which may actively alter a length thereof according to a force applied thereon, thereby buffering a load force between the base 110 and the carrier 120 caused by an external force. The telescopic rod 201 may be a pneumatic cylinder, a hydraulic cylinder or a linear actuator. However, the scopes of this disclosure should not be limited to this. FIG. 4B is a perspective view showing another type of the linear buffer of the hexapod calibration device according to the first embodiment of this disclosure. For example, the telescopic rod 202 of the buffer 200 as shown in FIG. 4B is a passive telescopic buffer element, which may passively alter a length thereof by a force applied thereon, thereby buffering a load force between the base 110 and the carrier 120 caused by an external force. The telescopic rod 202 may be a columnar spring, a hydraulic buffer rod or a pneumatic buffer rod.

The load-bearing compensator 300 is connected to the base 110 and the carrier 120 and arranged along a predetermined operation direction 303 to resist a load force between the base 110 and the carrier 120 along the predetermined operation direction 303. Specifically, the predetermined operation direction 303 is generally determined according to a predetermined main loading direction of the hexapod calibration device.

In one example of this embodiment, a normal direction of the carrier 120 is predetermined as the main loading direction, so that the predetermined operating direction 303 is defined along the central axis 101, but the scopes of this disclosure should not be limited to this. The load-bearing compensator 300 has a plurality of linear elastic elements 310 disposed around a central axis 101. Specifically, the linear elastic elements 310 are identical cylindrical springs. The linear elastic element 310 may elastically deform when loaded with a force in the main loading direction so as to generate an elastic force along the central axis 101, thereby providing a compensation force along the central axis 101. Furthermore, when the carrier 120 deflects relative to the base 110, the linear elastic elements 310 may provide a compensation force on the deflected side.

According to this embodiment, the load-bearing compensator 300 may have a second sub-seat 302 and a second sub-seat 302, the linear elastic element 310 is connected to the first sub-seat 301 and the second sub-seat 302, the first sub-seat 301 is detachably connected to one of the base 110 and the carrier 120, and the second sub-seat 302 is detachably connected to another of the base 110 and the carrier 120, so that it is easy to assemble the load-bearing compensator 300 between the base 110 and the carrier 120, and it is easy to detach the load-bearing compensator 300 and replace it with another load-bearing compensator 300 operation.

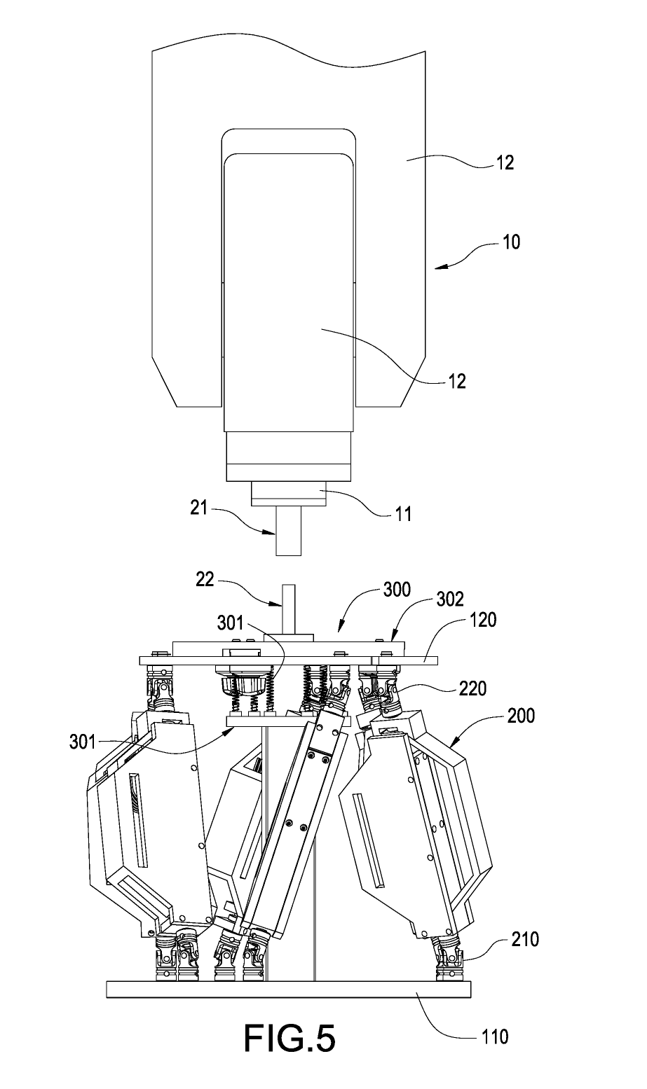

FIG. 5 is a perspective view showing the hexapod calibration device in operation. According to an operation of this embodiment, a part 21 is assembled to a counterpart 22 via a transferring device, the transferring device is a robotic arm, the robotic arm has a claw portion 11 and multiple arm portions 12 movably connected with each other, the claw portion 11 is connected to one of the arm portions 12. The carrier 120 is fixed, the part 21 is held by the claw portion 11 and may be moved with motions of the arm portion 12, and the counterpart 22 is carried on the carrier 120. The counterpart 22 may be directly connected to the carrier 120 or connected to the carrier 120 via an indirect connection such as the second sub-seat 302.

In an operation of assembling the part 21 to the counterpart 22 by the transferring device, the part 21 may cause a resistance against the hexapod calibration device when contacting the counterpart 22 if the part 21 is skewed and therefore misaligned to the counterpart part 22. The resistance causes deformation on the six linear buffers 200 to give forces to the counterpart 22 along multiple directions, thereby deflecting the counterpart 22 to align the part 21.

In this embodiment, the linear buffers 200 are pre-compressed by a weight of the counterpart 22 along the predetermined operating direction 303 when the counterpart 22 is carried on the carrier 120, and moving strokes of the linear buffers 200 in the predetermined operating direction 303 are therefore reduced. The compensation force of the load-bearing compensator 300 is disposed along the predetermined operation direction 303 to resist the weight of the counterpart 22, thereby recovering the moving strokes of the linear buffers 200 in the predetermined operation direction 303. Accordingly, a range of calibration of the hexapod calibration device in each direction is increased.

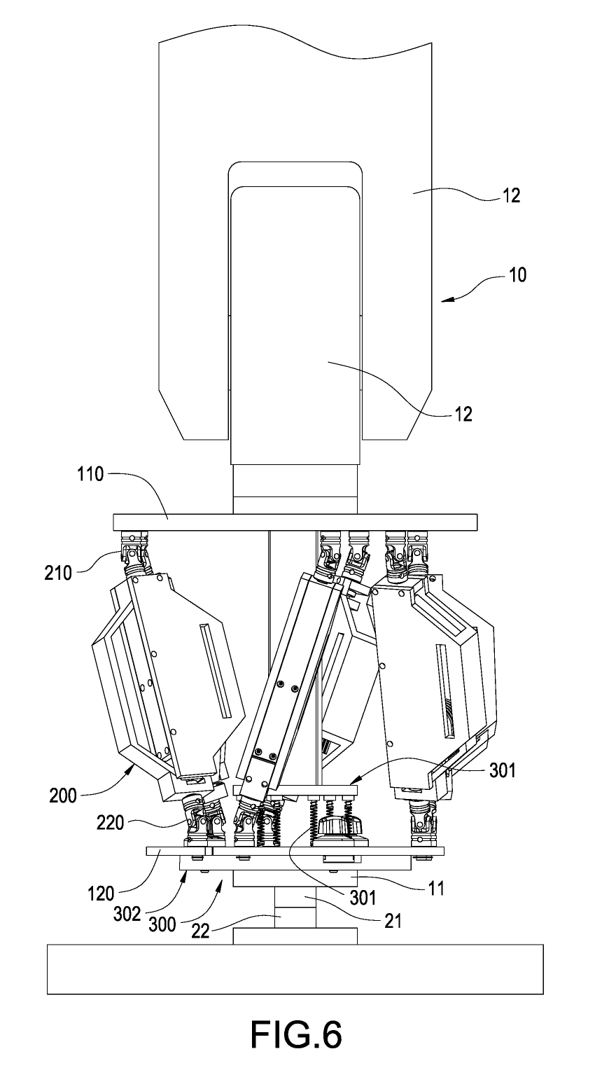

FIG. 6 is another perspective view showing the hexapod calibration device in operation, but the operation of this disclosure should not be limited to the embodiment. According to one example as shown in FIG. 6, the hexapod calibration device may be disposed as a segment of a robot arm, namely the base 110 and the carrier 120 of the hexapod calibration device are respectively connected to two parts of the robot arm (e.g. connected to the claw portion 11 and the arm portion 12, or arranged between two arm portion 12). Accordingly, predetermined operation directions 303 may be defined according to various positions, operation or load of object 23 of the hexapod calibration device.

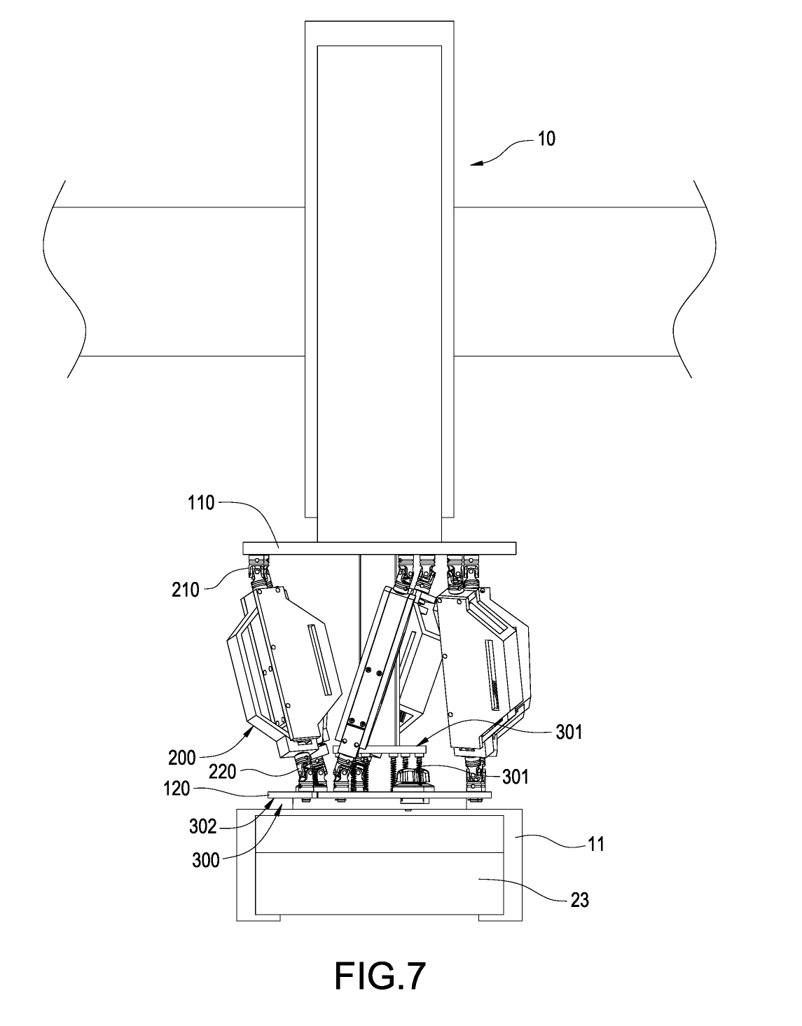

FIG. 7 is further another perspective view showing the hexapod calibration device in operation. According to FIG. 7, the hexapod calibration device may be arranged as a bridge crane for moving a heavy object 23, and a claw portion 11 is provided below the transferring device for holding the object 23.

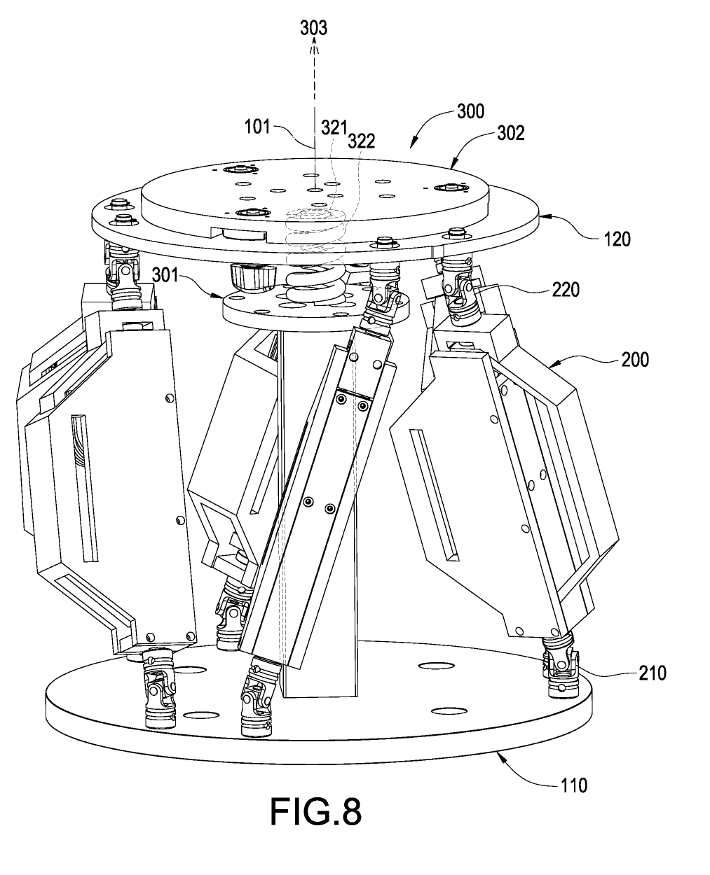

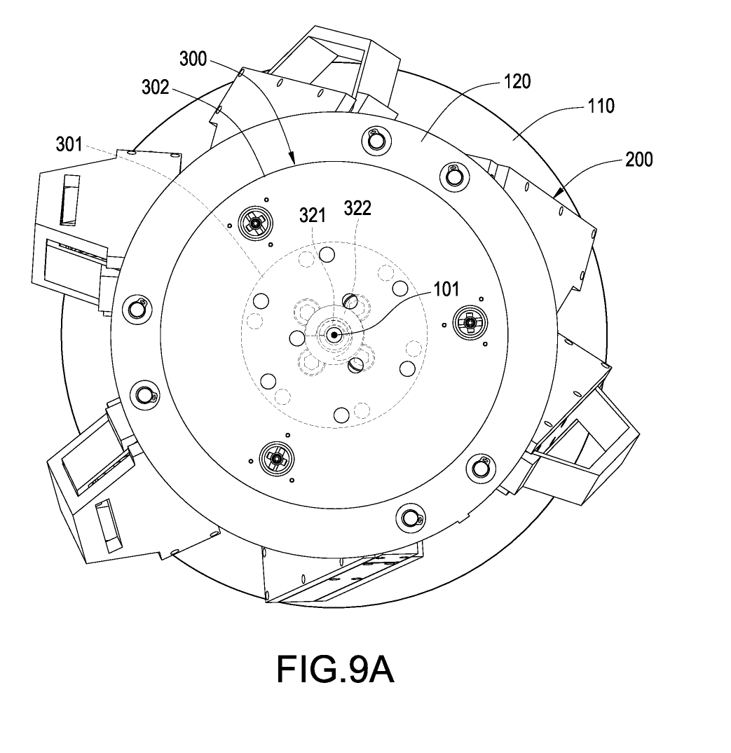

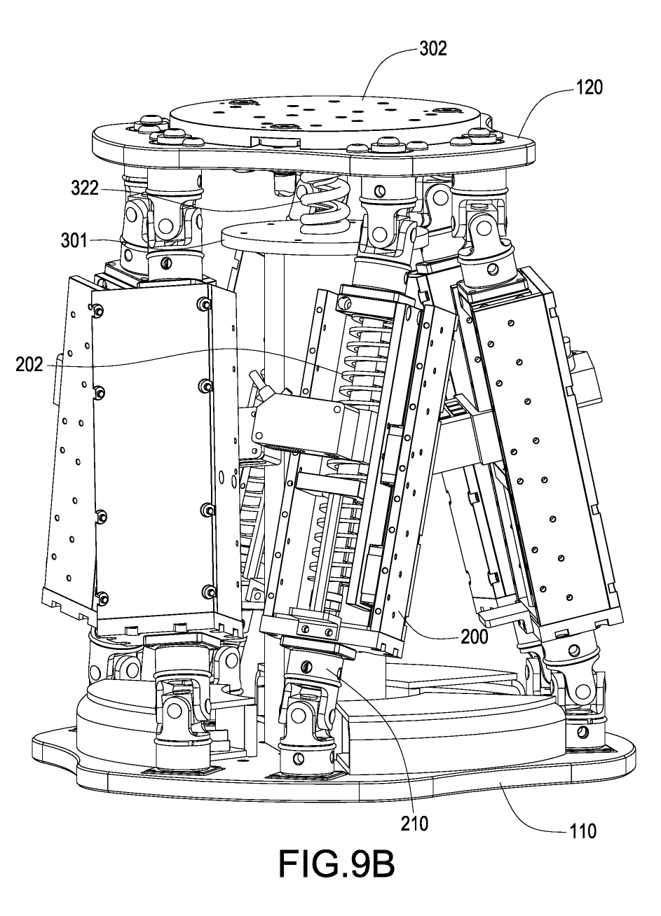

FIG. 8 is a perspective view showing the hexapod calibration device according to the second embodiment of this disclosure. FIG. 9A is a top view of the hexapod calibration device according to the second embodiment of the disclosure. According to FIGS. 8 and 9A, the second embodiment of this disclosure provides a hexapod calibration device having a base 110, a carrier 120, six linear buffers 200 and a load-bearing compensator 300. Specifically, the base 110, the carrier 120 and six of the linear buffers 200 have structures the same as that of the first embodiment mentioned above, the linear buffer 200 may be an active telescopic buffering element such as the telescopic rod 201 as shown in FIG. 8. FIG. 9B is a perspective view showing another type of the linear buffer of the hexapod calibration device according to the second embodiment of this disclosure. According to FIG. 9B, the linear buffer 200 may be a passive telescopic buffering element such as the telescopic rod 202 as shown in FIG. 9B, the description for what the same as the first embodiment will not be repeated in this embodiment. This embodiment is different from the first embodiment in the structure of the load-bearing compensator 300, details will be described in the following paragraphs.

In this embodiment, the predetermined operation direction 303 is defined along the central axis 101, the load-bearing compensator 300 has at least one linear elastic element disposed along the central axis 101, such as a first linear elastic element 321 and a second linear elastic element 322 a as shown in FIG. 1. Single linear elastic element (the first linear elastic element 321 or the second linear elastic element 322) may be disposed as a simplest embodiment to achieve the predetermined function of this disclosure. According to this embodiment, the load-bearing compensator 300 has a plurality of linear elastic elements disposed as a coaxial arrangement about the central axis 101, and the linear elastic elements are telescoped into one another.

Specifically, all of the linear elastic elements are cylindrical spring, the linear elastic elements have the first linear elastic element 321 and the second linear elastic element 322 with various diameters, the first linear elastic element 321 and the second linear elastic element 322 may be disposed with modulus of elasticity the same as each other or different from each other. The first linear elastic element 321 and the second linear elastic element 322 are disposed in the coaxial arrangement along the predetermined operation direction 303 (namely about the central axis 101), and the second linear elastic element 322 is inserted in the first linear elastic element 321 to perform an efficient spatial arrangement. The first linear elastic element 321 and the second linear elastic element 322 mentioned above may respectively deform to generate an elastic force along the central axis 101 when applied with a force along the main loading direction, thereby providing a compensation force along the central axis 101.

According to this embodiment, the load-bearing compensator 300 may has a second sub-seat 302 and a second sub-seat 302, the linear elastic element is connected to the first sub-seat 301 and the second sub-seat 302, the first sub-seat 301 is detachably connected to one of the base 110 and the carrier 120, and the second sub-seat 302 is detachably connected to another of the base 110 and the carrier 120, so that it is easy to assemble the load-bearing compensator 300 between the base 110 and the carrier 120, and it is easy to detach the load-bearing compensator 300 and replace with another load-bearing compensator 300 operation.

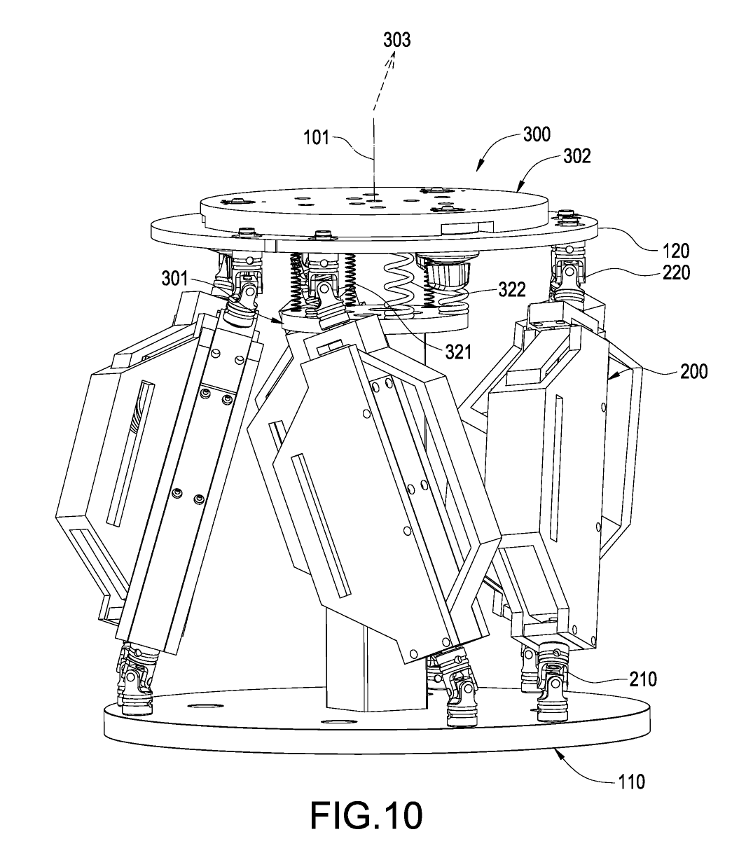

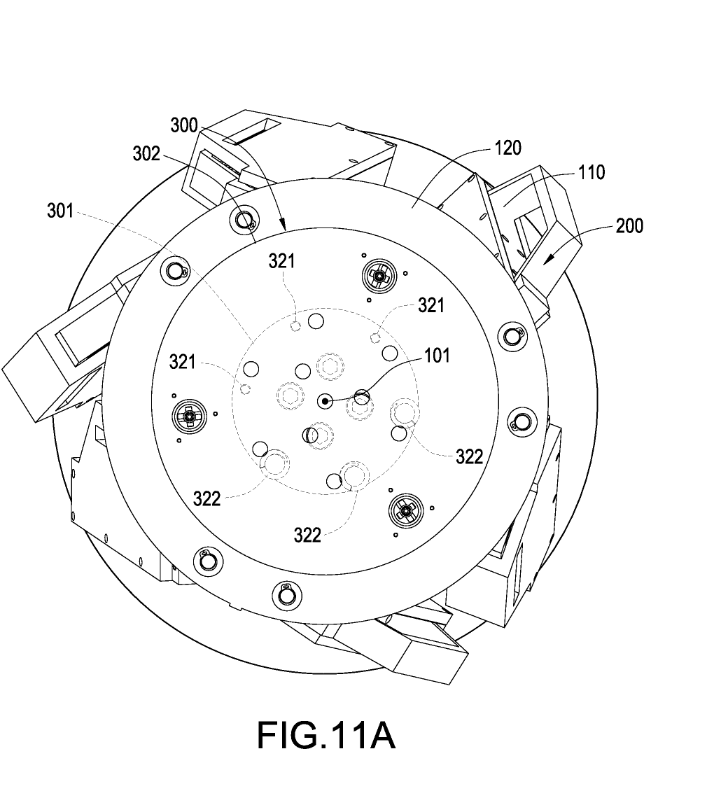

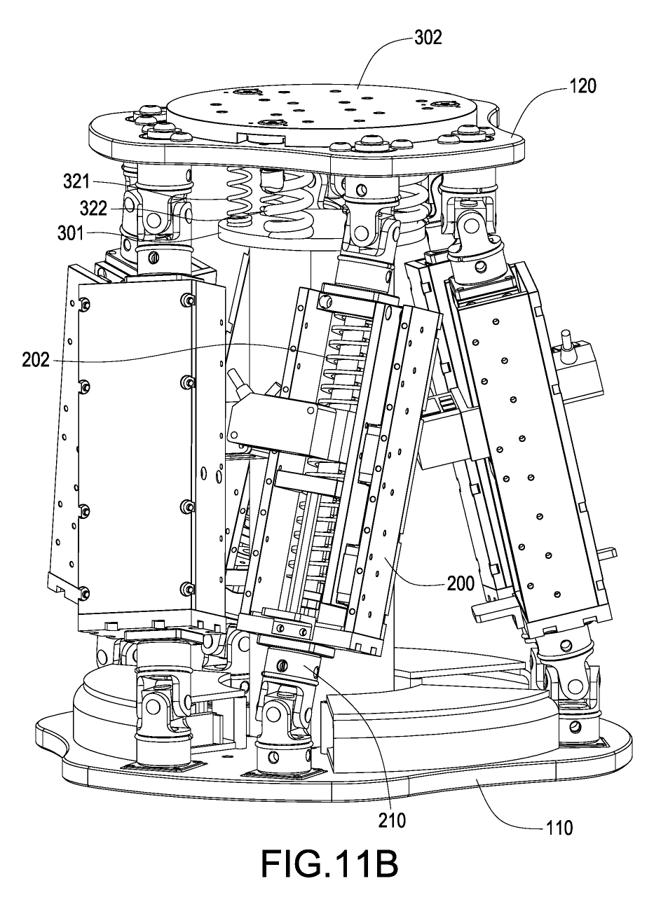

FIG. 10 is a perspective view showing the hexapod calibration device according to the third embodiment of this disclosure. FIG. 11A is a top view of the hexapod calibration device according to the third embodiment of the disclosure. According to FIGS. 10 and 11A, the third embodiment of this disclosure provides a hexapod calibration device having a base 110, a carrier 120, six linear buffers 200 and a load-bearing compensator 300. Specifically, the base 110, the carrier 120 and six of the linear buffers 200 have structures the same as that of the first embodiment mentioned above, the linear buffer 200 may be an active telescopic buffering element such as the telescopic rod 201 as shown in FIG. 8. FIG. 11B is a perspective view showing another type of the linear buffer of the hexapod calibration device according to the third embodiment of this disclosure. The linear buffer 200 may be a passive telescopic buffering element such as the telescopic rod 202 as shown in FIG. 11B, the description for what the same as the first embodiment will not be repeated in this embodiment. This embodiment is different from the first embodiment in the structure of the load-bearing compensator 300, details will be described in the following paragraphs.

According to this embodiment, the predetermined operation direction 303 is defined with a deflection angle relative to the central axis 101, The cause may be corresponding to an ununiform loading object with one side heavier than other sides on the carrier 120, or corresponding to an assembling operation along a nonvertical direction performed by the hexapod calibration device arranged on a robotic arm with a weigh applied on a side of the hexapod calibration device. According to this embodiment, the load-bearing compensator 300 has at least one linear elastic element arranged along the central axis 101 such as a first linear elastic element 321 or a second linear elastic element 322 as shown in the figures, and at least one of the linear elastic elements is eccentrically arranged relative to the central axis 101. Specifically, the load-bearing compensator 300 has the first linear elastic element 321 and the second linear elastic element 322 with modulus of elasticities different from each other, and the first linear elastic element 321 and the second linear elastic element 322 are respectively disposed at two different sides of the central axis 101. The linear elastic elements 310 deform to generate elastic forces combined into a resultant force along the predetermined operation direction 303 as the compensation force when a load force is applied between the base 110 and the carrier 120.

According to this embodiment, the load-bearing compensator 300 may have a second sub-seat 302 and a second sub-seat 302, the linear elastic element 310 is connected to the first sub-seat 301 and the second sub-seat 302, the first sub-seat 301 is detachably connected to one of the base 110 and the carrier 120, and the second sub-seat 302 is detachably connected to another of the base 110 and the carrier 120, so that it is easy to assemble the load-bearing compensator 300 between the base 110 and the carrier 120, and it is easy to detach the load-bearing compensator 300 and replace with another load-bearing compensator 300 operation.

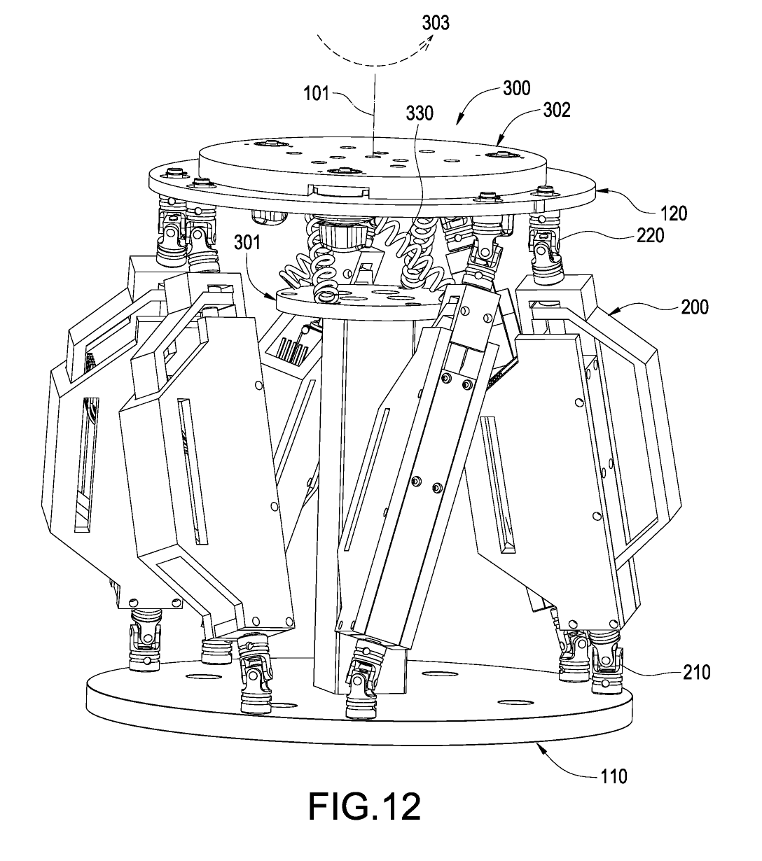

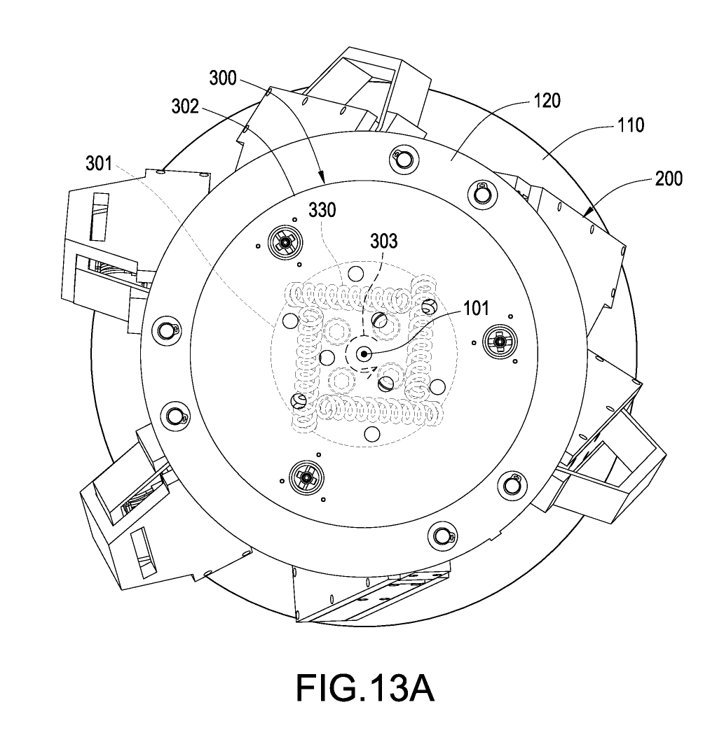

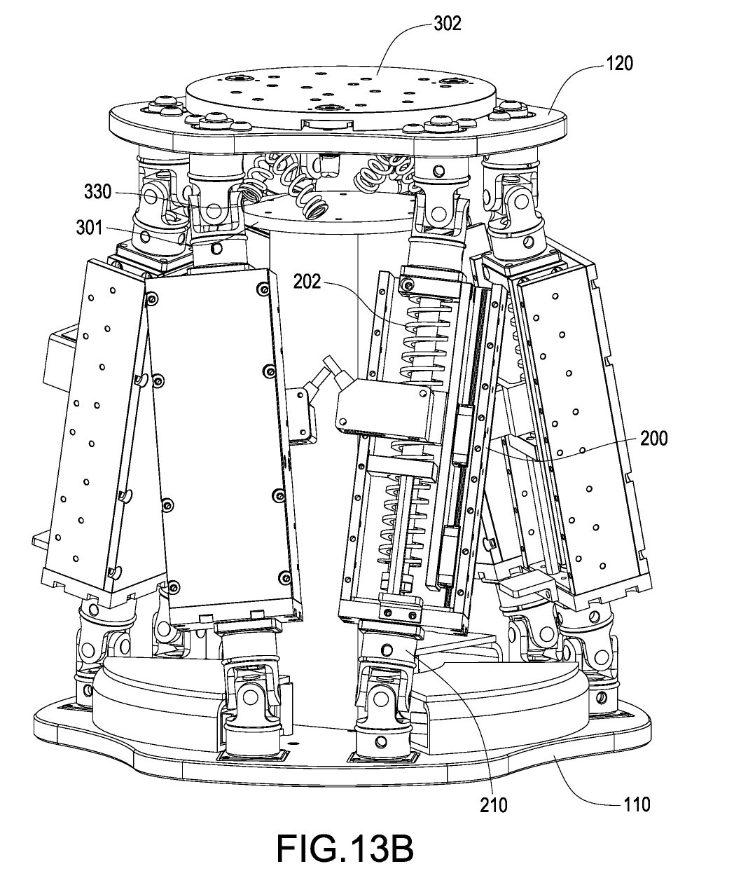

FIG. 12 is a perspective view showing the hexapod calibration device according to the fourth embodiment of this disclosure. FIG. 13A is a top view of the hexapod calibration device according to the fourth embodiment of the disclosure. According to FIGS. 12 and 13A, the fourth embodiment of this disclosure provides a hexapod calibration device having a base 110, a carrier 120, six linear buffers 200 and a load-bearing compensator 300. Specifically, the base 110, the carrier 120 and six of the linear buffers 200 have structures the same as that of the first embodiment mentioned above, the linear buffer 200 may be an active telescopic buffering element such as the telescopic rod 201 as shown in FIG. 10. FIG. 13B is a perspective view showing another type of the linear buffer of the hexapod calibration device according to the fourth embodiment of this disclosure. The linear buffer 200 may be a passive telescopic buffering element such as the telescopic rod 202 as shown in FIG. 13B, the description for what the same as the first embodiment will not be repeated in this embodiment. This embodiment is different from the first embodiment in the structure of the load-bearing compensator 300, details will be described in the following paragraphs.

In this embodiment, the predetermined operation direction 303 is defined as a circumferential direction relative to the central axis 101, because the hexapod calibration device is arranged on the robot arm to perform a rotational assembly. In this embodiment, the load-bearing compensator 300 has a plurality of linear elastic elements 330 disposed around a central axis 101. Specifically, the linear elastic elements 330 are identical cylindrical springs. Each of the linear elastic elements 330 is tilted. The linear elastic elements 330 are tilted toward the same directions in the circumferential direction of the arrangement of the linear elastic elements 330. When the load-bearing compensator 300 is loaded with a torsion, an elastica deformations may occur in each of the linear elastic elements 330 so as to generate an elastic force in the circumferential direction about the central axis 101, thereby providing a compensation force in the circumferential direction about the central axis 101. At the same time, the elastic force generated by each of the linear elastic elements 330 has a component force in a direction parallel to the central axis 101. The component forces generated by the linear elastic elements 330 form a resultant force in a direction parallel to the central axis 101 so as to provide a compensation force on the central axis 101.

According to this embodiment, the load-bearing compensator 300 may has a second sub-seat 302 and a second sub-seat 302, the linear elastic element 330 is connected to the first sub-seat 301 and the second sub-seat 302, the first sub-seat 301 is detachably connected to one of the base 110 and the carrier 120, and the second sub-seat 302 is detachably connected to another of the base 110 and the carrier 120, so that it is easy to assemble the load-bearing compensator 300 between the base 110 and the carrier 120. Since the load-bearing compensator 300 is not directly connected to the linear buffer 200 and not directly connected to the base 110 or the carrier 120, the base 110 and the carrier 120 are fixed by the linear buffer 200 during an assembling process or a disassembling process to the load-bearing compensator 300. Therefore, it is convenient to disassemble the load-bearing compensator 300 and replace it with another load-bearing compensator 300 according to various usages.

Accordingly, the hexapod calibration device of this disclosure has a load-bearing compensator 300, thereby providing compensation force(s) along specific direction(s) for resisting the weight of the load object, so that preload to the linear buffer 200 may be reduced, and the hexapod calibration device may operate a calibration with a larger range.

While this disclosure has been described by means of specific embodiments, numerous modifications and variations may be made thereto by those skilled in the art without departing from the scope and spirit of this disclosure set forth in the claims.

What is claimed is:

1. A hexapod calibration device, comprising:
a base;
a carrier, arranged parallel to the base, and a central axis defined on the center line connecting the carrier and the base;
six linear buffers, arranged around the central axis and respectively pivoted with the base and the carrier, and each of the linear buffers comprising two ends respectively provided with universal joints for pivoting; and
a load-bearing compensator, comprising at least one linear elastic element connected to the base and the carrier, wherein a compensation force along the operation direction is generated by an elastic deformation of the at least one linear elastic element when a load force is applied between the base and the carrier.

2. The hexapod calibration device according to claim 1, wherein the at least one linear elastic element is disposed on the central axis.

3. The hexapod calibration device according to claim 2, wherein the load-bearing compensator comprises a plurality of linear elastic elements coaxially disposed on the central axis.

4. The hexapod calibration device according to claim 3, wherein the linear elastic elements are telescoped into one another.

5. The hexapod calibration device according to claim 1, wherein the load-bearing compensator comprises a plurality of linear elastic elements disposed as an arrangement surrounding the central axis.

6. The hexapod calibration device according to claim 5, wherein the linear elastic elements are arranged parallel to the central axis.

7. The hexapod calibration device according to claim 5, wherein each of the linear elastic elements is tilted.

8. The hexapod calibration device according to claim 7, wherein each of the linear elastic elements is tilted toward the same direction relative to a circumferential direction of the arrangement of the linear elastic elements.

9. The hexapod calibration device according to claim 1, wherein the at least one linear elastic element is eccentrically arranged about the central axis.

10. The hexapod calibration device according to claim 1, wherein the load-bearing compensator comprises a plurality of linear elastic elements, the linear elastic elements comprise a first linear elastic element and second linear elastic element with a modulus of elasticity the same as that of the first linear elastic element, and the first linear elastic element and the second linear elastic element are respectively disposed at different sides of the central axis.

11. The hexapod calibration device according to claim 1, wherein the load-bearing compensator comprises a first sub-seat and a second sub-seat, the first sub-seat is detachably connected to one of the base and the carrier, the second sub-seat is detachably connected to another one of the base and the carrier, and the at least one linear elastic element is connected to the first sub-seat and the second sub-seat.
